(19) United States
(12) Patent Application Publication
(10) Pub. No.: US 2024/0185146 A1
(43) Pub. Date: Jun. 6, 2024

(54) SYSTEM AND METHOD FOR MANAGING PEER TO PEER LAUNDRY SERVICE

(71) Applicant: Software Profiles Inc., Mineral Wells, TX (US)

(72) Inventors: Rehan Wahab, Keller, TX (US); Umar Farooq, North Richland Hills, TX (US)

(21) Appl. No.: 18/073,557

(22) Filed: Dec. 2, 2022

(51) Int. Cl. G06Q 10/0631

(52) U.S. Cl. CPC G06Q 10/0631

(57) ABSTRACT

The present disclosure describes techniques for managing peer to peer laundry service. The techniques include the step of receiving a request for obtaining laundry service from a customer, extracting pickup/drop location from the request, broadcasting the request to one or more laundry service providers located within a predetermined distance from the pickup/drop location, selecting a laundry service provider from the one or more laundry service providers based on one or more parameters, and transmitting a message to the selected laundry service provider for picking up one or more items for laundry from the pickup/drop location. The selected laundry service provider delivers the one or more items at the pickup/drop location after the laundry service is finished. Thus, the techniques facilitate peer to peer or individual to individual laundry service which empowers an individual to become a laundry service provider.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to laundry services, and more specifically, to a system and method for managing peer to peer laundry service.

### 2. Description of Related Art

This background information is intended to further educate the reader as to additional aspects of the prior art and may present examples of specific aspects of the prior art that is not to be construed as limiting the disclosure of the present application.

Doing laundry to provide clean clothes is a common activity for the general public. There are many people who either dislike doing laundry at home or are unable to do so for a variety of reasons. There are different types of laundry services, such as pickup laundry services, commercial laundry services, dry cleaning services, and laundromat self-service.

One type of common laundry service is a laundromat or self-service laundry. Laundromats are an essential business in urban communities. Laundromats are found in locations such as hospitals, student residences at universities, or apartment blocks. Laundromat owners may employ someone to oversee and maintain the general day to day operations of the laundromat. Some laundries may employ staff to provide additional services for the customers such as stain treatment, dry cleaning, ironing, folding, and mending services. In such laundromats, customers will typically drop off their laundry at the laundromat for cleaning and collect the laundry on the delivery date from the laundromat.

A traditional laundry service requires a customer to go to a laundromat or in some cases a laundromat provides a pick up laundry service from the customer's home or business office at a predetermined schedule. The laundry service vendor then provides the laundry services and returns the clean laundry to the customer's home or business.

With the improvement of living standards worldwide, more and more people are looking to have their clothes washed through a laundry service. Further, in the current global economy, more and more people are looking for additional sources of income through freelance work. For these and other reasons, there exists a need in the art to provide a technique which overcomes the above-mentioned problems and provides a system and method for efficiently and effectively managing a peer to peer laundry service that provides additional and convenient options for customers looking for laundry services and also empowers an individual to become a laundry service provider.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure. The disclosure of the present application addresses the above stated deficiencies with laundry services.

In one non-limiting aspect of the present disclosure, a method of managing peer to peer laundry service is disclosed. The method comprises receiving a request for obtaining laundry service from a customer, extracting pickup/drop location from the request, broadcasting the request to one or more laundry service providers located within a predetermined distance from the pickup/drop location, selecting a laundry service provider from the one or more laundry service providers based on one or more parameters, and transmitting a message to the selected laundry service provider for picking up one or more items for laundry from the pickup/drop location. The selected laundry service provider delivers the one or more items at the pickup/drop location after the laundry is finished. Thus, the method facilitates peer to peer or individual to individual laundry service which empowers an individual with a washing machine, a dryer and an iron to become a laundry service provider.

In another non-limiting aspect of the present disclosure, the request for obtaining laundry service at least comprises a quantity of items, type of items, one or more specific instructions, pickup/drop location, pickup time, and delivery time.

In another non-limiting aspect of the present disclosure, the one or more parameters for selecting the laundry service provider at least comprises first laundry service provider to respond to the broadcasted request, previous ratings of the laundry service provider, and customer preferred laundry service providers.

In yet another non-limiting aspect of the present disclosure, the method further comprises collecting a payment from the customer through at least one payment mode selected by the customer, deducting a service fee from the payment received from the customer, and transferring a remainder of the payment to an account of the selected laundry service provider.

In yet another non-limiting aspect of the present disclosure, the receiving of the request from the customer comprise displaying, via a mobile application, one or more categories of items to the customer, selecting, by the customer, the one or more items from the one or more categories along with a respective quantity of the one or more items and one or more specific instructions, displaying a total amount for the laundry service of the selected one or more items, and receiving the pickup/drop location, the pickup time, and the delivery time from the customer.

In yet another non-limiting aspect of the present disclosure, the request is placed by a mobile application installed on a device of the customer, and wherein the method further comprises registering at least one customer and the one or more laundry service providers on the mobile application using user credentials, wherein the user credential comprises one or more of: username, mobile number, password, gender, email address, date of birth, driver's license, and banking detail.

In yet another non-limiting aspect of the present disclosure, the method further comprises storing one or more details associated with the request of the customer in a database.

In yet another non-limiting aspect of the present disclosure, the method further comprises receiving a rating for each of the laundry service providers from the respective customer post-delivery and receiving a rating for each customer from the respective laundry service provider post-delivery, calculating an average of ratings received for each of the customers and the laundry service providers, and maintaining the calculated average of ratings for each of the customers and the laundry service providers in a database.

In yet another non-limiting aspect of the present disclosure, the method further comprises sending a reminder to the laundry service providers after every predetermined interval of time.

In yet another non-limiting aspect of the present disclosure, the method further comprises maintaining a record of payments made to each of the one or more laundry service providers in a database, generating a tax form annually for each of the one or more laundry service providers, and providing the generated tax form to the respective laundry service provider.

In yet another non-limiting aspect of the present disclosure, a computing system for managing peer to peer laundry service is disclosed. The computing system comprises a memory for storing a plurality of instructions, and a processing unit in communication with the memory capable of executing the plurality of instructions. The computing system further comprises a user interface in communication with the memory and the processing unit. The user interface is configured to receive a request for obtaining laundry service from a customer. The processing unit is configured to extract pickup/drop location from the request, broadcast the request to one or more laundry service providers located within a predetermined distance from the pickup/drop location, select a laundry service provider from the one or more laundry service providers based on one or more parameters, and transmit a message to the selected laundry service provider for picking up one or more items for laundry from the pickup/drop location. The selected laundry service provider delivers the one or more items at the pickup/drop location after the laundry is finished. Thus, the computing system facilitates peer to peer or individual to individual laundry service which empowers an individual with a washing machine, a dryer and an iron to become a laundry service provider.

In yet another non-limiting aspect of the present disclosure, the processing unit is configured to collect a payment from the customer through at least one payment mode selected by the customer, deduct a service fee from the payment received from the customer, and transfer a remainder of the payment to an account of the selected laundry service provider.

In yet another non-limiting aspect of the present disclosure, to receive the request from the customer, the user interface is configured to display one or more categories of items to the customer, receive a selection of the one or more items from the one or more categories along with a respective quantity of the one or more items and one or more specific instructions, display a total amount for the laundry service of the selected one or more items, and receive the pickup/drop location, the pickup time, and the delivery time from the customer.

In yet another non-limiting aspect of the present disclosure, the user interface is configured to receive user credentials of at least one customer and the one or more laundry service providers, wherein the user credentials comprise one or more of: username, mobile number, password, gender, email address, date of birth, driver's license, and banking detail, and the processing unit is configured to register the at least one customer and the one or more laundry service providers on a mobile application installed on the respective device of the at least one customer and the one or more laundry service providers.

In yet another non-limiting aspect of the present disclosure, the user interface is configured to receive a rating for each of the laundry service providers from the respective customer post-delivery, and receive a rating for each customer from the respective laundry service provider post-delivery. The processing unit is configured to calculate an average of ratings received for each of the customers and the laundry service providers and maintain the calculated average of ratings for each of the customers and the laundry service providers in a database.

In yet another non-limiting aspect of the present disclosure, the processing unit is configured to send a reminder to the laundry service providers after every predetermined interval of time.

In yet another non-limiting aspect of the present disclosure, the processing unit is configured to store one or more details associated with the request of the customer in a database.

In yet another non-limiting aspect of the present disclosure, a non-transitory computer-readable medium having computer-readable instructions is disclosed. The computer-readable instructions when executed by a processor causes the processor to perform operations of obtaining a request for obtaining laundry service from a customer, extracting pickup/drop location from the request, broadcasting the request to one or more laundry service providers located within a predetermined distance from the pickup/drop location, selecting a laundry service provider from the one or more laundry service providers based on one or more parameters, and providing a message to the selected laundry service provider for picking up one or more items for laundry from the pickup/drop location, wherein the selected laundry service provider delivers the one or more items at the pickup/drop location after the laundry is finished.

The foregoing summary is illustrative only and is not intended to be in any way limiting. In addition to the illustrative aspects, and features described above, further aspects, and features will become apparent by reference to the drawings and the following detailed description.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 shows an exemplary environment capable of managing peer to peer laundry service, in accordance with an aspect of the present disclosure;

FIG. 2 illustrates an exemplary communication environment between customers and laundry service providers, in accordance with some aspects of the present disclosure;

FIG. 3 is a block diagram illustrating an exemplary customer interaction for placing request for laundry service, in accordance with an aspect of the present disclosure;

FIG. 4 shows an exemplary environment for locating a laundry service provider for a customer, in accordance with an aspect of the present disclosure;

FIG. 5 is a block diagram illustrating a computing system for managing peer to peer laundry service, in accordance with an aspect of the present disclosure;

FIG. 6 is a block diagram illustrating a computing system for managing peer to peer laundry service s, in accordance with an aspect of the present disclosure; and

FIG. 7 depicts a flowchart illustrating an exemplary method of managing peer to peer laundry service, in accordance with an aspect of the present disclosure;

While the system and method of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the aspects of the present disclosure so as not to obscure the figures with details that will be readily apparent to those skilled in the art having the benefit of the description herein.

### DETAILED DESCRIPTION

Illustrative embodiments of the system of the present application are provided herein. It should be appreciated that in the development of any actual embodiment, various implementation-specific decisions are required to achieve the developer's specific goals, such as compliance with system-related and business-related constraints, which vary from one implementation to another. Moreover, it should be appreciated that such a development effort might be complex and time-consuming but would nevertheless be a routine undertaking for those of ordinary skill in the art having the benefit of this disclosure.

The system should be understood, both as to its structure and operation, from the accompanying drawings, taken in conjunction with the accompanying description. Various embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

For the purpose of promoting an understanding of the principles of the disclosure, reference will now be made to the aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present disclosure, the word “exemplary” is used herein to mean “serving as an example, instance, or illustration”. Any aspect or implementation of the present subject matter described herein as “exemplary” is not necessarily to be construed as preferred or advantageous over other aspects.

The terms “comprise”, “comprising”, or any other variations thereof, are intended to cover a non-exclusive inclusion, such that one or more devices or subsystems or elements or structures or components preceded by “comprises a” does not, without more constraints, preclude the existence of other devices, sub-systems, additional sub-modules. Appearances of the phrase “in an aspect”, “in another aspect” and similar language throughout this specification may, but not necessarily do, all refer to the same aspect.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client or server computer system) configured by an application may constitute a “module” (or “subsystem”) that is configured and operated to perform certain operations. In one aspect, the “module” or “subsystem” may be implemented mechanically or electronically, so a module includes dedicated circuitry or logic that is permanently configured (within a special-purpose processor) to perform certain operations. In another aspect, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

The present disclosure describes techniques for managing peer to peer laundry service. The techniques include the step of receiving a request for obtaining laundry service from a customer, extracting pickup/drop location from the request, broadcasting the request to one or more laundry service providers located within a predetermined distance from the pickup/drop location, selecting a laundry service provider from the one or more laundry service providers based on one or more parameters, and transmitting a message to the selected laundry service provider for picking up one or more items for laundry from the pickup/drop location. The selected laundry service provider delivers the one or more items at the pickup/drop location after the laundry service is finished.

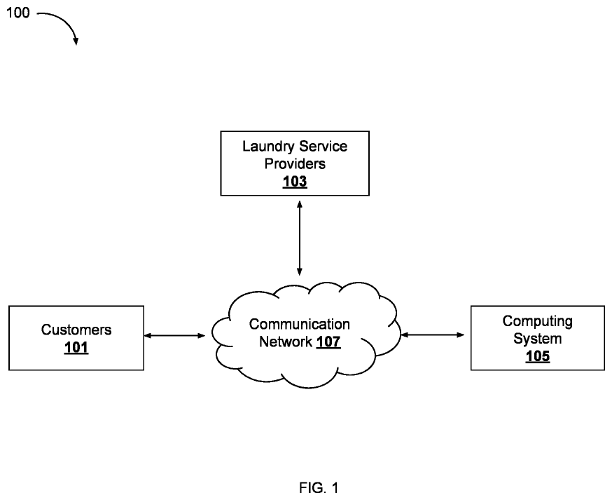

FIG. 1 shows an exemplary environment 100 capable of managing peer to peer laundry service, in accordance with an aspect of the present disclosure.

Referring now to the drawings wherein like reference characters identify corresponding or similar elements throughout the various views, FIG. 1 shows an exemplary environment 100 capable of managing peer to peer laundry service, in accordance with an aspect of the present disclosure.

In an aspect of the present disclosure, the environment 100 may comprise customers 101, and laundry service providers 103 communicatively connected to a computing system 105 through a communication network 107. The communication network 107 may be the internet, intranet, a local area network (LAN), a wide area network (WAN), wireless LAN (WLAN), wireless fidelity (Wi-Fi), and similar networks.

In an exemplary aspect of the present disclosure, the communication network 107 may be the internet. The computing system 105 may be a central server, such as a cloud server or a remote server. Further, the one or more electronic devices include a mobile/web application to access the computing system 105 via the communication network 107.

In an aspect of the present disclosure, the customers 101 and the laundry service providers 103 may have a respective electronic device for connecting to the computing system 105. In an exemplary aspect of the present disclosure, the one or more electronic devices may be a tablet computer, smartphone and the like. In one non-limiting aspect, the computing system 105 may be a mobile application installed on the respective electronic devices of the customers 101 and the laundry service providers 103.

In an aspect, a customer may place a request/order for obtaining laundry service at the computing system 105 that manages peer to peer laundry service. The laundry service may comprise all types of laundry services such as washing of clothing and other textiles, and their drying and ironing, dry cleaning, etc. However, the laundry service is not limited to the above example, any other type of laundry service that may be provided by a laundry service provider is well within the scope of present disclosure.

The computing system 105 may extract location information of the customer from the request. In one non-limiting aspect, the computing system 105 may receive a location of the customer from a GPS module present on the electronic device of the customer. In another non-limiting aspect, the location information may be entered by the customer while raising a request for obtaining the laundry service.

The computing system 105 may then broadcast a request for the laundry service along with the necessary details to a number of laundry service providers 103 present in the vicinity of the customer. The necessary details may comprise the list of items along with their respective quantities, specific instructions, pickup/drop location, and delivery timeline, etc. The broadcast region may be predefined and may be adjusted based on a preference of the customer.

In an aspect, one or more laundry service providers 103 may accept the request of the customer and the computing system 105 may select one of the one or more laundry service providers 103 who have accepted the request for laundry service based on one or more parameters such as first laundry service provider to accept the request, which is discussed in detail in below aspects.

After the selection, the selected laundry service provider is instructed by the computing system 105 via a notification/message on the respective electronic device to pick up one or more items for laundry from a location provided by the customer. The one or more items may comprise, but not limited to, clothes, bedsheets, linen, shoes, etc.

At the time of pickup, the laundry service provider may verify the request/order and enter any pre-existing conditions with respect to the one or more items through the mobile/web application. The laundry service provider may then deliver the one or more items to the customer once the laundry service is completed.

In an exemplary aspect of the present disclosure, the mobile application may work with any software known to a person skilled in the art. The mobile application may support Android platforms, iOS platforms or the like. The mobile application may require integration with a plurality of laundry service providers to allow for expansion. The customers 101 may use the computing system 105 to request and pay for the laundry service via the mobile application. Further, the customers 101 may also use the computing system 105 to receive one or more notifications corresponding to the status of the laundry via the mobile application installed on their respective device. However, the scope of the present disclosure is not limited to the above example and customers may also place the order and interact with the computing system 105 through a web application or website.

In an exemplary aspect of the present disclosure, the laundry service providers 103 may comprise laundry service systems that are connected to the communication network 105 through a laptop computer, desktop computer, tablet computer, smartphone, wearable device, smart watch and the like. The laundry service systems may be used by laundry managers, admins and the like. Further, the laundry service providers 103 may use a web browser and a mobile application to access the computing system 105 via the communication network 107.

In an aspect of the present disclosure, the laundry service providers may use a web application through the web browser to access the computing system 105 and receive an instruction/message from the computing system 105 to pick up one or more items for laundry service from the customer. The computing system 105 may comprise a plurality of modules. Details on the plurality of modules have been elaborated in subsequent paragraphs of the present description.

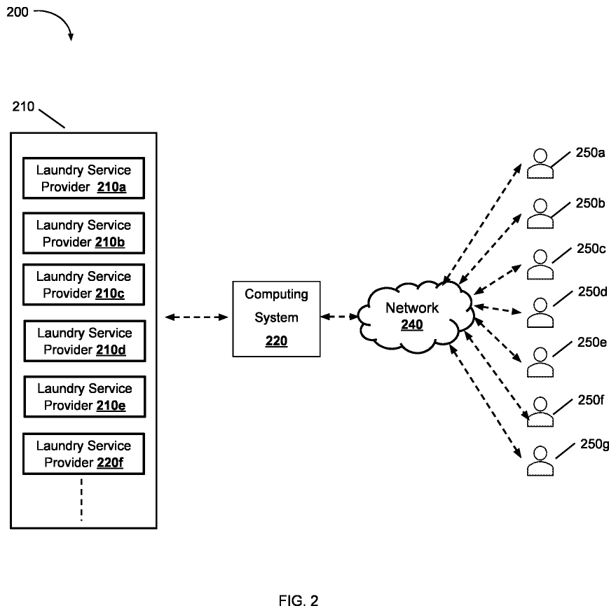

FIG. 2 illustrates an exemplary communication environment 200 between customers and laundry service providers, in accordance with some aspects of the present disclosure.

In an aspect of the present disclosure, the communication environment 200 between customers and laundry service providers may comprise a plurality of laundry service providers 210a, 210b, 210c, . . . and a computing system 220 similar to that of the computing system 103 as discussed in above aspects.

The communication environment 200 may further comprise a number of users/customers 250a, 250b, 250c, . . . 250g connected to the computing system 220 or accessing the computing system 220 through their respective one or more electronic devices. The customers 250a-g may access the computing system 220 via a mobile or web application present on the respective one or more electronic devices.

In one non-limiting aspect, the customers 250a, 250b, 250c, . . . 250g may register on the mobile or web application and create an account/profile for placing an order/request for obtaining laundry service and the plurality of laundry service providers 210a, 210b, 210c, . . . may have to register on the mobile or web application and create an account for receiving request/order for laundry service.

Both customers 250a, 250b, 250c, . . . 250g and laundry service providers 210a, 210b, 210c, . . . are registered and verified using user credentials that include username, mobile number, password, gender, email address, date of birth, driver's license, and banking detail, etc. The banking detail may include the necessary information such as credit card details or any other details of the customers and laundry service providers for executing a transaction. In one aspect, the account may be verified by sending an automated message on email and phone number.

The customers 250a-g may order/request for laundry service through the mobile or web application on their respective electronic devices. The computing system 220 may broadcast the request only to the laundry service providers present within a predetermined distance from the customer and receive one or more acceptance from one or more laundry service providers for the request. In one non-limiting aspect, the predetermined distance may vary based on the customer preference. In another non-limiting aspect, the predetermined distance may be decided by the computing system 220.

The computing system 220 may then select a laundry service provider from the one or more laundry service providers based on one or more predefined criteria/parameters. The one or more criteria/parameters may be predefined by the customer via the mobile/web application present on the electronic device of the customer. In one non-limiting aspect, the one or more criteria/parameters may comprise the first laundry service provider who accepts the request, ratings of the laundry service provider, or customer preferred laundry service provider.

The computing system 220 may then notify/instruct the selected laundry service provider by transmitting a message to the laundry service provider for picking up the one or more item for laundry from the pickup location. At the time of the pickup, the laundry service provider may verify the request/order and enter any pre-existing conditions with respect to the one or more items through the mobile/web application. The laundry service provider may then deliver the one or more items to the customer once the laundry is completed. The computing system 220 may collect payment from the customer, deduct a service fee, and transfer the remaining amount to an account wallet of the laundry service provider. The laundry service provider may withdraw/transfer the amount from the account wallet to the bank account as per convenience.

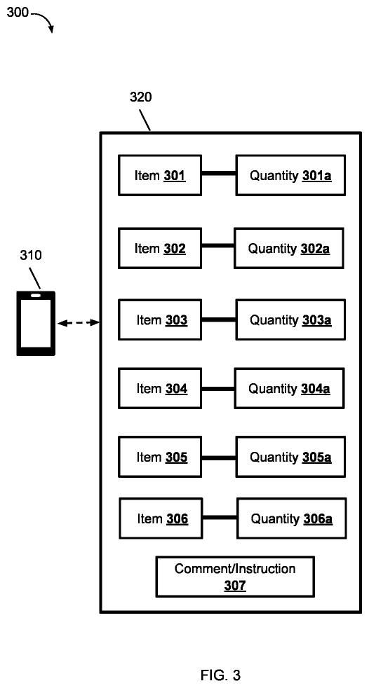

FIG. 3 is a block diagram 300 illustrating an exemplary customer interaction for placing a request for laundry service, in accordance with an aspect of the present disclosure.

In an embodiment of the present disclosure, the customer interaction 300 involves customer interacting with a computing system as discussed in above aspects of the present disclosure. The customer may access the computing system through one or more electronic devices 310 that may comprise a mobile/web application for accessing the computing system via the communication network such as the internet. The computing system may be a central server, such as cloud server, local server, or a remote server.

In an aspect of the present disclosure, the user interface 320 of the mobile/web application may comprise a predefined list of items for selection. The customer may then select the quantity of such items from a drop-down menu present next to the predefined list of items. The quantity of the item may be mentioned by number of items or total weight of the items.

In an aspect of the present disclosure, the user interface 320 may show a plurality of items 301, 302, 303, 304, . . . 306 for which the laundry service is provided and their respective quantity 301a, 302a, 303a, 304a, . . . 306a for placing the request for laundry service through the mobile/web application. The customer may also provide one or more instructions 307 such as the laundry to be folded, ironed, on a hanger, dry cleaned, etc. In one non-limiting aspect, the user interface 320 of the mobile/web application may display a total amount for laundry service based on the selection of the items, respective quantities and comment/instructions 307.

The customer may verify the total amount and confirm the request/order on the confirmation page. The order may then be picked-up, verified, and delivered based on the procedure as discussed in above aspects.

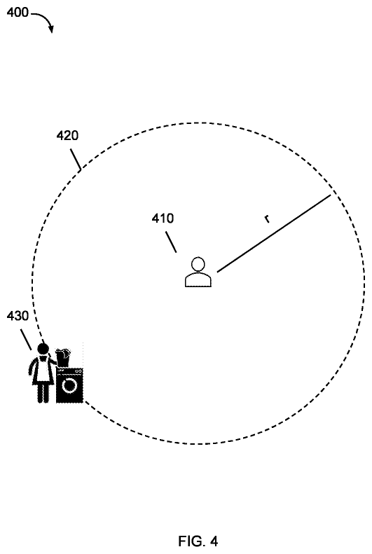

FIG. 4 shows an exemplary environment 400 for locating a laundry service provider for a customer, in accordance with an aspect of the present disclosure.

In an aspect of the present disclosure, the customer 410 may place a request/order for obtaining laundry service through a mobile/web application present on the electronic device of the customer 410. The customer 410 may enter the pickup location manually or by providing the mobile/web application access to the GPS location of the electronic device, while placing the request for obtaining laundry service.

Once the request is placed through the mobile application, the computing system may extract location information or pickup location of the customer 410 and determine one or more laundry service providers present within a predefined radius ‘r’ from the customer 410. In one non-limiting aspect, the predefined radius ‘r’ may be defined by the customer 410 for quick pick up and delivery of the laundry.

The computing system may then broadcast the request to the one or more laundry service providers present within the predefined radius ‘r’ from the customer 420. The predefined radius ‘r’ may define an area 420 around the customer 410. The computing system may receive an acceptance from the one or more laundry service providers in response to receiving the broadcasted request.

The computing system may then select a laundry service provider 430 who first accepted the broadcasted request and transmit a message comprising the details of the request to the selected laundry service provider 430 to pick up one or more items for laundry. In case the selected laundry service provider abandons the request before pickup, the computing system may repeat the broadcast step and select a new laundry service provider for providing laundry service.

At the time of the pickup, the selected laundry service provider may verify the request/order and enter any pre-existing conditions with respect to the one or more items through the mobile/web application. The selected laundry service provider 430 may deliver the one or more items to the customer 410 after the laundry service has been completed.

In one non-limiting aspect of the present disclosure, the laundry service provider may provide a real time update of the status of the request to the customer through the mobile/web application.

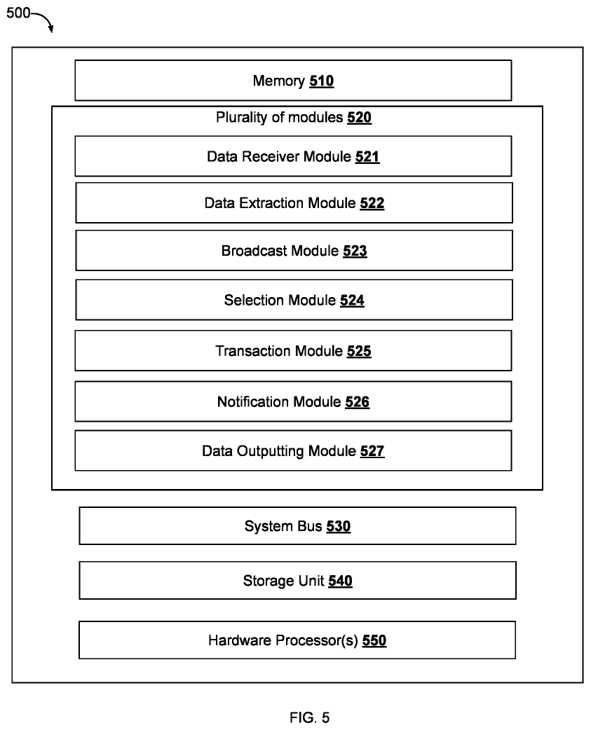

FIG. 5 is a block diagram illustrating a computing system 500 for managing peer to peer laundry service, in accordance with an aspect of the present disclosure.

In an aspect of the present disclosure, the computing system 500 may comprise one or more hardware processors 550, a memory 510 and a storage unit 540. The one or more hardware processors 550, the memory 510 and the storage unit 540 are communicatively coupled through a system bus 530 or any similar mechanism. The computing system 550 may further comprise a plurality of modules 520. The plurality of modules 520 includes a data receiver module 521, a data extraction module 522, a broadcast module 523, a selection module 524, a transaction 525, a notification module 526, and a data outputting module 527.

In one non-limiting aspect, the plurality of modules 520 may be stored in the memory 510 in the form of programmable instructions executable by the one or more hardware processors 550. In another non-limiting aspect, each of the plurality of modules 520 may comprise respective specific hardware circuitry required for carrying out the below mentioned functionalities.

The one or more hardware processors 550, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 550 may also include embedded controllers, such as generic or programmable logic devices or arrays, application specific integrated circuits, single-chip computers, and the like.

The memory 510 may be non-transitory volatile memory and non-volatile memory. The memory 510 may be coupled for communication with the one or more hardware processors 550 and the plurality of modules 520, such as being a computer-readable storage medium. The one or more hardware processors 550 may execute machine-readable instructions and/or source code stored in the memory 510. A variety of machine-readable instructions may be stored in and accessed from the memory 510. The memory 510 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present aspect, the memory 204 includes the plurality of modules 520 stored in the form of machine-readable instructions on any of the above-mentioned storage media and may be in communication with and executed by the one or more hardware processors 550.

The storage unit 540 may be a cloud storage or a local file directory within a remote server. The storage unit 540 may store customer details and laundry service provider details including Personal Identifiable Information (PII) of the customer and the laundry service provider, respectively. The PII may be the information used to identify the customer and laundry service provider, such as name and contact information. Further, the storage unit 540 may store one or more requests/orders placed by the one or more customers for obtaining laundry services. The storage unit 540 also stores the respective ratings/feedback of the customer and the laundry service provider with respect to each of the one or more orders.

The data receiver module 521 may receive an order/request from a customer for obtaining laundry service. The request may contain one or more items along with their respective quantity, pickup/delivery location, special instructions such as folding, ironing, etc., delivery time. The hardware processor may calculate a total amount for providing the laundry service based on the list of items, respective quantities, pickup/delivery location and delivery time. The data outputting module 527 may display the total amount for payment and the data receiver module 521 may complete the request/order from the customer. In an aspect, the data receiver module 521 and data outputting module 527 may comprise a user interface.

The data extraction module 522 may be configured to extract the location information i.e., the pickup/drop location from the request. The pickup/drop location may be used by the computing system 500 for connecting to a laundry service provider present in close proximity to the customer. The broadcast module 523 may use the extracted location information and may broadcast the received request to all the laundry service providers present at predetermined distance from the customers pickup/drop location.

The broadcasted request may be accepted by one or more laundry service providers who are ready to provide laundry service to the customer. The selection module 524 may be configured to select one laundry service provider from laundry service providers accepting the request based on one or more parameters. The one or more parameters for selecting the laundry service provider at least comprises first laundry service provider to respond to the broadcasted request, previous ratings of the laundry service provider, and customer preferred laundry service providers.

The notification module 526 may notify the selected laundry service provider to pick up the laundry. The selected laundry service provider may verify the request/order at the time of pickup and the data receiver module 521 may receive any pre-existing conditions with respect to the one or more items after the selected laundry service provider verifies the request.

In an aspect of the present disclosure, the transaction module 525 may debit the total amount from an account of the customer using the credit card details provided at the time of signing up. The selected laundry service provider may then do the laundry for the one or more items based on the broadcasted request and deliver the one or more items post laundry to the customer. The transaction module 525 may be operable to deduct a service fee from the total amount received from the customer and transfer the remaining amount to an account wallet of the laundry service provider. The laundry service provider may withdraw/transfer the amount from the wallet to the bank account of the laundry service provider.

In an aspect of the present disclosure, the notification module 526 may be configured to notify the laundry service provider with a reminder for timely delivering the laundry to the customer. In one non-limiting aspect, the data receiver module 521 may receive a rating of the laundry service provider from the customer and the data receiver module 521 may also receive a rating of the customer from the laundry service provider. The received rating may be stored against the respective laundry service provider and the respective customer in the storage unit 540.

In an aspect of the present disclosure, the notification module 526 may regularly update the status of the laundry after pick up by the laundry service provider and the updated status may be notified to the customer at regular intervals.

In an aspect of the present disclosure, the mobile application associated with the customer has multiple graphical user interface screens for registration, login, dashboard, menu screen, contact list, profile edit, payment method and the like. The registration screen of the mobile application is used to register the customer when the customer is using the mobile application for the first time. There are multiple registration fields and buttons on the registration screen, such as phone number, password, confirm password, gender, email address, confirm email address, date of birth, I agree terms button and submit button. The customer may also have to add a username while registering. In an exemplary aspect of the present disclosure, the username may be an email address of the customer. When the customer clicks on the submit button, an email may be sent to an admin and the customer. The customer may need to confirm their account by clicking on the verification link sent to their email address and verification code sent by text to the one or more electronic devices. In one non-limiting aspect, the procedure is applicable for laundry service provider registration as well.

Further, the login screen of the mobile application is used by the customer to login by using their username and password chosen at the time of registration. When the customer logs in for the first time, the mobile application may keep the customer logged in till the customer manually logs out. There are multiple login fields and buttons on the login screen, such as username, password, sign in button, forgot password button and sign-up button. When the customer forgets his password, the customer has to click on the forgot password button. The customer has to provide his email address which is used at the time of registration to reset the password. When the customer provides the email address, the mobile application confirms if any account is associated with the provided email address. When it is confirmed that an account is associated with the provided email address, one email may be sent on the provided email address containing a link to reset the password. Furthermore, the dashboard screen of the mobile application is used by the customer to access various features and information, such as logo on top, profile picture of the customer, name of the user, list of available laundry service provider from whom the customer has already availed the laundry service, profile edit, setting, and sign out. In one non-limiting aspect of the present disclosure, the one or more above functionalities are also available for the laundry service providers registered on the mobile application.

Furthermore, the contact list screen of the mobile application may be used by the customer/laundry service provider to contact support for any issues or queries. The profile edit screen of the mobile application may be used by the customer to edit their PII, such as profile picture. Furthermore, the payment method screen of the mobile application may be used by the customer to perform payment of the request for laundry service. The payment method screen may be integrated using Application programming Interface (API) provided by the current Point of Sale (POS) system.

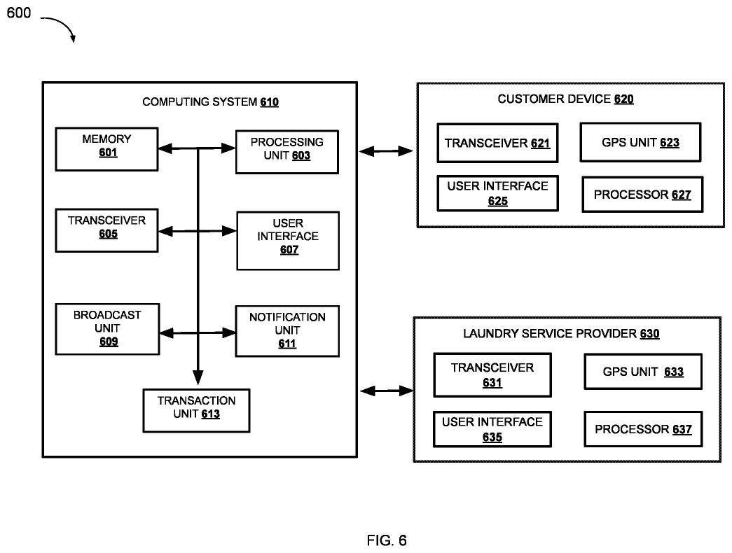

FIG. 6 is a block diagram illustrating a system 600 for managing peer to peer laundry services, in accordance with an aspect of the present disclosure.

In an aspect of the present disclosure, the system 600 may comprise a computing system 610, a customer device 620, and a laundry service provider device 630 communicatively connected with each other over a communication network. In one non-limiting aspect, the communication network may be the internet. The computing system 610 may be a central server, such as a cloud server or a remote server. Further, the one or more electronic devices of the customer and the laundry service device may include a mobile/web application to access the computing system 610 via the communication network. However, the communication network is not limited to the internet and a person skilled may use any other communication network known to him.

In an aspect of the present disclosure, the computing system 610 may comprise memory 601, processing unit 603, a transceiver 605, a user interface 607, a broadcast unit 609, a notification unit 611, and a transaction unit 613 in communicatively coupled with each other. The customer device 620 may comprise a transceiver 621, a GPS unit 623, a user interface 625, and a processor 627 in communication with each other. The laundry service provider device 630 may comprise a transceiver 631, a GPS unit 633, a user interface 635, and a processor 637 in communication with each other.

However, the hardware/software components of the computing system 610, the customer device 620, and the laundry service provider device 630 are not limited to above mentioned components and the computing system 610, the customer device 620, and the laundry service provider device 630 may comprise any other component required to carry out their respective functionalities.

In an aspect of the present disclosure, the memory 601 of the computing system 610 may be configured for storing a plurality of instructions. The processing unit in communication with the memory 601 may be capable of executing a plurality of instructions. The user interface 607 may be configured to receive a request for obtaining laundry service from a customer. The request for obtaining laundry service may comprise a quantity of items, type of items, one or more specific instructions, pickup/drop location, pickup time, and delivery time. The user interface 607 may be in communication with the user interface 625 of the customer device 620 for receiving the requests and other inputs from the customer.

In an aspect of the present disclosure, to receive the request from the customer, the user interface comprising a display unit is configured to display one or more categories of items to the customer. The customer may select one or more items that the customer wants laundry for. The user interface 607 may then be configured to receive the selection of the one or more items from the one or more categories along with a respective quantity of the one or more items and one or more specific instructions via a mobile application. The one or more specific instructions may comprise ironing, folding, etc.

The display unit may be then configured to display a total amount for the laundry service of the selected one or more items. The processing unit 603 may calculate a total amount for the laundry based on the type of items selected and their respective quantity. In one non-limiting aspect, every item displayed to the customer may have a particular cost based on the quantity and specific instruction provided by the customer and the total amount may be calculated accordingly. The user interface 607 may display the cost to the customer and shall receive the acceptance on the same, while submitting the request for the laundry service. The user interface 607 may then be configured to receive the pickup/drop location, the pickup time, and the delivery time from the customer.

In an aspect of the present disclosure, the pickup/drop location may be selected using a GPS unit 623 of the customer device 620. In one non-limiting aspect, the pickup/drop location may be manually entered by the customer via the user interface 625 of the customer device 620.

In an aspect of the present disclosure, after receiving the request, the processing unit 603 may be configured to extract the pickup/drop location from the request. The request received by the computing system may be embedded with the pickup/drop location of the customer. Then, the broadcast unit 609 may be configured to transmit/broadcast the request to all the laundry service providers present within a predetermined distance from the pickup/drop location or the location information associated with the customer, as discussed in explanation of FIG. 4.

In an aspect, one or more laundry service providers may accept the request and send an acknowledgement of the acceptance to the computing system 610. The processing unit 603 may be then configured to select a laundry service provider from the one or more laundry service providers based on one or more parameters. The one or more parameters for selecting the laundry service provider at least comprises first laundry service provider to respond to the broadcasted request, previous ratings of the laundry service provider, and customer preferred laundry service providers.

Once the laundry service provider is selected, the notification unit 611 may notify the selected laundry service provider about the selection. The notification may be transmitted via a message to the selected laundry service provider for picking up one or more items for laundry from the pickup/drop location.

In an aspect of the present disclosure, the selected laundry service provider may verify the items at the time of pickup and specify/enter any pre-existing condition related to the item via the user interface 635 of the laundry service provider device 630. After the verification, the items may be picked up by the laundry service provider. The transaction unit 613 along with the processing unit 603 may deduct the total amount agreed upon by the customer from an account of the customer based on the banking details such as credit card details provided by the customer at the time of registering on the laundry service application.

In an aspect of the present disclosure, the laundry service provider may do the laundry as per the instructions from the customer and deliver the laundry to the customer as per agreed delivery time. In one non-limiting aspect, the notification unit 611 may be configured to send a reminder to the laundry service providers after every predetermined interval of time for timely delivery of the laundry.

In one non-limiting embodiment of the present disclosure, the customer may check the items at the time of delivery and approve the delivery via the user interface 625 of the customer device 620. After delivery, the processing unit 603 and the transaction unit 613 may be configured to deduct a service fee from the amount/payment received from the customer, and transfer remaining of the payment to an account of the selected laundry service provider.

In one non-limiting aspect, the user interface 625 of the customer device 620 may be configured to receive a rating for each of the laundry service providers from the respective customer post-delivery. The user interface 635 of the laundry service provider may be configured to receive a rating for each customer from the respective laundry service provider post-delivery. The processing unit 603 may be configured to calculate an average of ratings received for each of the customers and the laundry service providers, and maintain the calculated average of ratings for each of the customers and the laundry service providers in a database.

In one non-limiting aspect, the user interface 607 is configured to receive user credentials of at least one customer and the one or more laundry service providers from their respective user interfaces 625 and 635. The user credentials comprise one or more of: username, mobile number, password, gender, email address, date of birth, driver's license, and banking detail. The processing unit 603 may be configured to register the at least one customer and the one or more laundry service providers on a mobile application installed on the respective device of the at least one customer and the one or more laundry service providers.

In one non-limiting aspect of the present disclosure, the processing unit 603 may be configured to store one or more details associated with the request of the customer in a database along with rating for future selection of the laundry service providers.

In another non-limiting aspect of the present disclosure, the processing unit 603 may be configured to maintain a record of payments made to each of the one or more laundry service providers in a database, generate a tax form annually for each of the one or more laundry service providers, and provide the generated tax form to the respective laundry service provider.

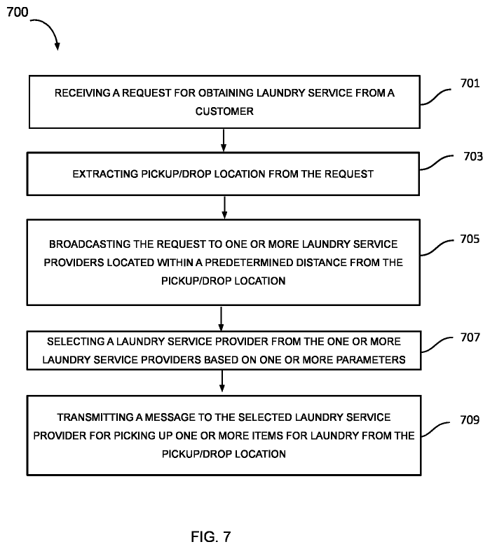

FIG. 7 depicts a flowchart illustrating an exemplary method of managing peer to peer laundry service, in accordance with an aspect of the present disclosure.

At step 701, a request for obtaining laundry service is received from a customer. The request for obtaining laundry service may comprise a quantity of items, type of items, one or more specific instructions, pickup/drop location, pickup time, and delivery time. The request may be received via a user interface of the customer device.

In an aspect of the present disclosure, the reception of the request from the customer comprises display of one or more categories of items to the customer. The customer may select one or more items that the customer wants laundry service for. The reception of the request from the customer further comprises selecting one or more items from the one or more categories along with a respective quantity of the one or more items and one or more specific instructions via a mobile application. The one or more specific instructions may comprise ironing, folding, etc.

The method 700 also includes displaying a total amount for the laundry service of the selected one or more items. The total amount may be calculated for the laundry based on the type of items selected and their respective quantity. In one non-limiting aspect, every item displayed to the customer may have a particular cost based on the quantity and specific instruction provided by the customer and the total amount may be calculated accordingly. The user interface may display the cost to the customer and shall receive the acceptance on the same, while submitting the request for the laundry service. The method 700 further includes receiving the pickup/drop location, the pickup time, and the delivery time from the customer.

In an aspect of the present disclosure, the pickup/drop location may be selected using a GPS unit of the customer device. In one non-limiting aspect, the pickup/drop location may be manually entered by the customer via the user interface of the customer device.

At step 703, the pickup/drop location may be extracted from the request. The request received may be embedded with the pickup/drop location of the customer. At step 705, the request from the customer is broadcasted or transmitted to all the laundry service providers present within a predetermined distance from the pickup/drop location or the location information associated with the customer, as discussed in explanation of FIG. 4.

In an aspect, one or more laundry service providers may accept the request and send an acknowledgement of the acceptance. At step 707, a laundry service provider from the one or more laundry service providers may be selected based on one or more parameters. The one or more parameters for selecting the laundry service provider at least comprises first laundry service provider to respond to the broadcasted request, previous ratings of the laundry service provider, and customer preferred laundry service providers.

At step 709, the selected laundry service provider is notified about the selection. The notification may be transmitted via a message to the selected laundry service provider for picking up the one or more items for laundry from the pickup/drop location. In case the selected laundry service provider abandons the assignment, a new laundry service prover is again selected based on the procedure discussed in the above aspect.

In an aspect of the present disclosure, the selected laundry service provider may verify the items at the time of pickup and specify/enter any pre-existing condition related to the item. After the verification, the items may be picked up by the laundry service provider. Post pickup, the method 700 further discloses collecting/deducting the total amount agreed upon by the customer from an account of the customer based on the banking details such as credit card details provided by the customer at the time of registering on the laundry service application.

In an aspect of the present disclosure, the laundry service provider may do the laundry as per the instructions from the customer and deliver the laundry to the customer as per agreed delivery time. In one non-limiting aspect, the method 700 further comprises sending a reminder to the laundry service providers after every predetermined interval of time for timely delivery of the laundry.

In one non-limiting embodiment of the present disclosure, the customer may check the items at the time of delivery and approve the delivery. After delivery, the method 700 further discloses deducting a service fee from the amount/payment received from the customer, and transferring remaining of the payment to an account of the selected laundry service provider. The laundry service provider may transfer the payment from the account wallet to the bank account of the laundry service provider.

In one non-limiting aspect, the method 700 further describes receiving a rating for each of the laundry service providers from the respective customer post-delivery and receiving a rating for each customer from the respective laundry service provider post-delivery, calculating an average of ratings received for each of the customers and the laundry service providers, and maintaining the calculated average of ratings for each of the customers and the laundry service providers in a database.

In one non-limiting aspect, registering of at least one customer and the one or more laundry service providers may comprise receiving user credentials of at least one customer and the one or more laundry service providers. The user credentials comprise one or more of: username, mobile number, password, gender, email address, date of birth, driver's license, and banking detail. The at least one customer and the one or more laundry service providers may be registered on a mobile application installed on the respective device of the at least one customer and the one or more laundry service providers.

In one non-limiting aspect of the present disclosure, the method 700 further comprises storing one or more details associated with the request of the customer in a database along with rating for future selection of the laundry service providers.

In another non-limiting aspect of the present disclosure, the method 700 further comprise maintaining a record of payments made to each of the one or more laundry service providers in a database, generating a tax form annually for each of the one or more laundry service providers, and providing the generated tax form to the respective laundry service provider.

The method 700 may be implemented in any suitable hardware, software, firmware, or combination thereof.

In another non-limiting aspect of the present disclosure, the steps of method 700 may be performed in an order different from the order described above.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of aspects. Those skilled in the art will appreciate that one or more of the described elements may well be combined into a single functional element. Alternatively, certain elements may be split into multiple functional elements. Elements from one aspect may be added to another aspect. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of aspects is by no means limited by these specific examples.

The aspects herein can comprise hardware and software elements. The aspects that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium may be an electronic, magnetic, optical, electromagnetic, infrared, cloud basedor semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the aspects may include a hardware configuration of an information handling/computer system in accordance with the aspects herein. The system herein comprises at least one processor or central processing unit (CPU). The CPUs are interconnected via system bus 530 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the aspects herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an aspect with several components in communication with each other does not imply that all such components are required. On the contrary, a variety of optional components are described to illustrate the wide variety of possible aspects of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other aspects of the invention need not include the device itself.

The illustrated steps are set out to explain the exemplary aspects shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed aspects. Also, the words “comprising”, “having”, “containing”, “including” and other similar forms are intended to be equivalent in meaning and be open-ended in that an item or items following any one of these words is not meant to be an exhaustive listing of such item or items or meant to be limited to only the listed item or items.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A method of managing peer to peer laundry service, the method comprising:
receiving a request for obtaining laundry service from a customer;
extracting pickup/drop location from the request;
broadcasting the request to one or more laundry service providers located within a predetermined distance from the pickup/drop location;
selecting a laundry service provider from the one or more laundry service providers based on one or more parameters; and
transmitting a message to the selected laundry service provider for picking up one or more items for laundry from the pickup/drop location, wherein the selected laundry service provider delivers the one or more items at the pickup/drop location after the laundry is finished.

2. The method of claim 1, wherein the request for obtaining laundry service at least comprises a quantity of items, type of items, one or more specific instructions, pickup/drop location, pickup time, and delivery time.

3. The method of claim 1, wherein the one or more parameters for selecting the laundry service provider at least comprises first laundry service provider to respond to the broadcasted request, previous ratings of the laundry service provider, and customer preferred laundry service providers.

4. The method of claim 1, further comprising:
collecting a payment from the customer through at least one payment mode selected by the customer;
deducting a service fee from the payment received from the customer; and
transferring remaining of the payment to an account of the selected laundry service provider.

5. The method of claim 1, wherein receiving the request from the customer comprises:
displaying, via a mobile application, one or more categories of items to the customer;
selecting, by the customer, the one or more items from the one or more categories along with a respective quantity of the one or more items and one or more specific instructions;
displaying a total amount for the laundry service of the selected one or more items; and
receiving the pickup/drop location, the pickup time, and the delivery time from the customer.

6. The method of claim 1, wherein the request is placed by a mobile application installed on a device of the customer, and wherein the method further comprises:
registering at least one customer and the one or more laundry service providers on the mobile application using user credentials, wherein the user credential comprises one or more of: username, mobile number, password, gender, email address, date of birth, driver's license, and banking detail.

7. The method of claim 1, further comprising:
storing one or more details associated with the request of the customer in a database.

8. The method of claim 1, further comprising:
receiving a rating for each of the laundry service providers from the respective customer post-delivery and receiving a rating for each customer from the respective laundry service provider post-delivery;
calculating an average of ratings received for each of the customers and the laundry service providers; and
maintaining the calculated average of ratings for each of the customers and the laundry service providers in a database.

9. The method of claim 1, further comprising:
sending a reminder to the laundry service providers after every predetermined interval of time.

10. The method of claim 1, further comprising:
maintaining a record of payments made to each of the one or more laundry service providers in a database;
generating a tax form annually for each of the one or more laundry service providers; and
providing the generated tax form to the respective laundry service provider.

11. A computing system for managing peer to peer laundry service, the computing system comprising:
a memory for storing a plurality of instructions;
a processing unit in communication with the memory capable of executing the plurality of instructions; and
a user interface in communication with the memory and the processing unit, the user interface configured to:
receive a request for obtaining laundry service from a customer, wherein the processing unit is configured to:
extract pickup/drop location from the request,
broadcast the request to one or more laundry service providers located within a predetermined distance from the pickup/drop location,
select a laundry service provider from the one or more laundry service providers based on one or more parameters, and
transmit a message to the selected laundry service provider for picking up one or more items for laundry from the pickup/drop location, wherein the selected laundry service provider delivers the one or more items at the pickup/drop location after the laundry is finished.

12. The computing system of claim 11, wherein the request for obtaining laundry service at least comprises a quantity of items, type of items, one or more specific instructions, pickup/drop location, pickup time, and delivery time.

13. The computing system of claim 11, wherein the one or more parameters for selecting the laundry service provider at least comprises first laundry service provider to respond to the broadcasted request, previous ratings of the laundry service provider, and customer preferred laundry service providers.

14. The computing system of claim 11, wherein the processing unit is configured to:
collect a payment from the customer through at least one payment mode selected by the customer,
deduct a service fee from the payment received from the customer, and
transfer remaining of the payment to an account of the selected laundry service provider.

15. The computing system of claim 11, wherein to receive the request from the customer, the user interface is configured to:
display one or more categories of items to the customer,
receive a selection of the one or more items from the one or more categories along with a respective quantity of the one or more items and one or more specific instructions,
display a total amount for the laundry service of the selected one or more items, and
receive the pickup/drop location, the pickup time, and the delivery time from the customer.

16. The computing system of claim 11, wherein:
the user interface is configured to receive user credentials of at least one customer and the one or more laundry service providers,
wherein the user credentials comprise one or more of: username, mobile number, password, gender, email address, date of birth, driver's license, and banking detail, and
the processing unit is configured to register the at least one customer and the one or more laundry service providers on a mobile application installed on the respective device of the at least one customer and the one or more laundry service providers.

17. The computing system of claim 11, wherein:
the user interface is configured to:
receive a rating for each of the laundry service providers from the respective customer post-delivery, and
receive a rating for each customer from the respective laundry service provider post-delivery;
the processing unit is configured to:
calculate an average of ratings received for each of the customers and the laundry service providers, and
maintain the calculated average of ratings for each of the customers and the laundry service providers in a database.

18. The computing system of claim 17, wherein the processing unit is configured to send a reminder to the laundry service providers after every predetermined interval of time.

19. The computing system of claim 11, wherein the processing unit is configured to store one or more details associated with the request of the customer in a database.

20. A non-transitory computer-readable medium having computer-readable instructions that when executed by a processor causes the processor to perform operations of:
obtaining a request for obtaining laundry service from a customer,
extracting pickup/drop location from the request;
broadcasting the request to one or more laundry service providers located within a predetermined distance from the pickup/drop location;
selecting a laundry service provider from the one or more laundry service providers based on one or more parameters; and
providing a message to the selected laundry service provider for picking up one or more items for laundry from the pickup/drop location, wherein the selected laundry service provider delivers the one or more items at the pickup/drop location after the laundry is finished.
